(19) United States
(12) Patent Application Publication
(10) Pub. No.: US 2023/0119103 A1
(43) Pub. Date: Apr. 20, 2023

(54) TRAINING DEVICE, CLASSIFICATION DEVICE, TRAINING METHOD, AND TRAINING PROGRAM

(71) Applicant: NIPPON TELEGRAPH AND TELEPHONE CORPORATION, Tokyo (JP)

(72) Inventors: Taishi NISHIYAMA, Musashino-shi, Tokyo (JP); Atsutoshi KUMAGAI, Musashino-shi, Tokyo (JP); Kazunori KAMIYA, Musashino-shi, Tokyo (JP)

(73) Assignee: NIPPON TELEGRAPH AND TELEPHONE CORPORATION, Tokyo (JP)

(21) Appl. No.: 17/766,531

(22) PCT Filed: Oct. 11, 2019
(86) PCT No.: PCT/JP2019/040337

§ 371 Date: Apr. 5, 2022

(51) Int. Cl. G06N 5/022

(52) U.S. Cl. CPC G06N 5/022

(57) ABSTRACT

A score calculation unit (123) calculates a score for each of one or more pieces of data that are each known to be a negative example or a positive example by using a score function for calculating the score from features of the data according to parameters. Further, an index calculation unit (124) calculates, in a result of classification from a classification performed based on the score calculated by the score calculation unit (123), an index that increases as a true positive rate for a false positive rate being within a predetermined section increases, the index increasing as a ratio of positive example data to data whose score is equal to a predetermined value increases. Further, an update unit (125) updates the parameter so that the index calculated by the index calculation unit (124) is optimized.

### TECHNICAL FIELD

The present invention relates to a learning device, a classification device, a learning method, and a learning program.

### BACKGROUND ART

Binary classification is known as one machine learning method. In binary classification, based on a score calculated from the feature value of data, for example, a classification is performed whether an email is a spam email, whether a cancer test result is positive or negative, and the like.

Here, the result of binary classification can be evaluated using various performance indexes such as Accuracy, Precision, True Positive Rate (TPR), and the like. However, it may not always be appropriate to perform a classification based on such performance indicators. For example, consider a classification for an imbalanced situation in which there are present 99 healthy patients and 1 cancer patient. In this case, if all 100 patients are classified as healthy patients, the correct answer rate is as high as 99%. However, such a result is not a desirable result because any cancer patient of interest fails to be detected.

On the other hand, the AUC (Area Under the Curve) is known as an index for evaluation. The AUC corresponds to the area under an ROC (Receiver Operating Characteristic) curve. Accordingly, it can be said that the AUC is an index in consideration of both the magnitude of a true positive rate (TPR) and a false positive rate (FPR). However, in some practical tasks, the TPR for low false positive rate (FPR) is regarded as being important. For example, in determining whether or not cancer is present, if there are many false positives, the cancer will be determined for a healthy person, which is a problem in practical use in a hospital. Therefore, in practice, it is important how much cancer can be detected (for the TPR) when false positive is suppressed to some extent (e.g., the FPR is 1%). In such a case, it is desirable to maximize the true positive rate (TPR) for a certain false positive rate (e.g., an FPR of 1%). Accordingly, a method of maximizing a part of AUC is desired. This area will be hereinafter referred to as pAUC, which is derived from a part of AUC (partial AUC).

### CITATION LIST

### Patent Literature

[PTL 1] Japanese Patent Application Publication No. 2017-102540
[PTL 2] Japanese Patent Application Publication No. 2017-126158

### Non Patent Literature

[NPL 1] Narasimhan, H. et al., “A structural svm based approach for optimizing partial auc.” ICML, vol. 28. (2013)
[NPL 2] Narasimhan, H. et al., “SVMpAUCtight: a new support vector method for optimizing partial auc based on a tight convex upper bound.” KDD, p. 167-175. ACM (2013)

### SUMMARY OF THE INVENTION

### Technical Problem

However, the conventional pAUC maximization method has a problem that it may be difficult to properly evaluate the binary classification for the target data in which pieces of data having the same score are present.

For example, a pAUC can be determined using approximation with an empirical distribution. In that case, for example, for given pieces of data having the same score as illustrated in FIG. 6, a pAUC based on an empirical distribution and a pAUC based on the original ROC curve may deviate significantly from each other. Specifically, for the range of 0.25 to 0.75 of FPR in FIG. 6, the TPR does not change as the FPR changes. On the other hand, in that same range, the TPR of the original ROC curve increases as the FPR increases.

### Means for Solving the Problem

In order to solve the problems described above and achieve an object, a learning device according to the present invention includes a score calculation unit that calculates a score for each of one or more pieces of data that are each known to be a negative example or a positive example by using a score function for calculating the score from a feature of the data according to a parameter; an index calculation unit that calculates, in a result of classification from a classification performed based on the score calculated by the score calculation unit, an index that increases as a true positive rate for a false positive rate being within a predetermined section increases, the index increasing as a ratio of positive example data to data whose score is equal to a predetermined value increases; and an update unit that updates the parameter so that the index calculated by the index calculation unit is optimized.

### Effects of the Invention

According to the present invention, it is possible to perform appropriate evaluation of the binary classification even when pieces of data having the same score are present in the target data.

### BRIEF DESCRIPTION OF DRAWINGS

FIG. 1 is a diagram illustrating a configuration example of a classification device according to a first embodiment.

FIG. 2 is a diagram for explaining classification results.

FIG. 3 is a diagram illustrating an example of an ROC curve and an AUC.

FIG. 4 is a diagram illustrating an example in which AUCs are equal but pAUCs are different.

FIG. 5 is a diagram for explaining a method of calculating the lengths of respective parts related to an empirical distribution.

FIG. 6 is a diagram illustrating an example of a pAUC of the original ROC curve and a pAUC based on an empirical distribution.

FIG. 7 is a flowchart illustrating a flow of learning processing of the classification device according to the first embodiment.

FIG. 8 is a diagram illustrating an example of a computer that executes a classification program.

### DESCRIPTION OF EMBODIMENTS

Embodiments of a learning device, a classification device, a learning method, and a learning program according to the present application will be described below in detail with reference to the drawings. Note that the present invention is not limited to the embodiments described below. In addition, the classification device in the embodiments also functions as a learning device.

[Structure of First Embodiment]

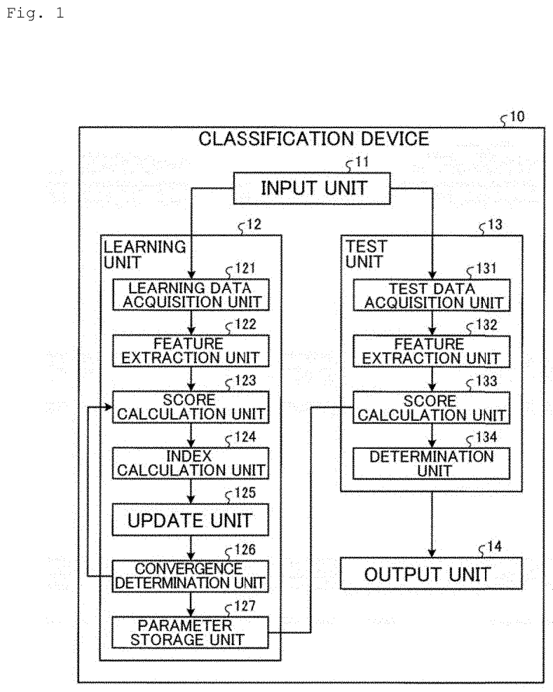

First, a configuration of a classification device according to a first embodiment will be described with reference to FIG. 1. FIG. 1 is a diagram illustrating a configuration example of a classification device according to a first embodiment. A classification device 10 trains, based on feature values extracted from data, a binary model that classifies the data into either positive or negative examples. The classification device 10 can also classify test data using the trained binary model.

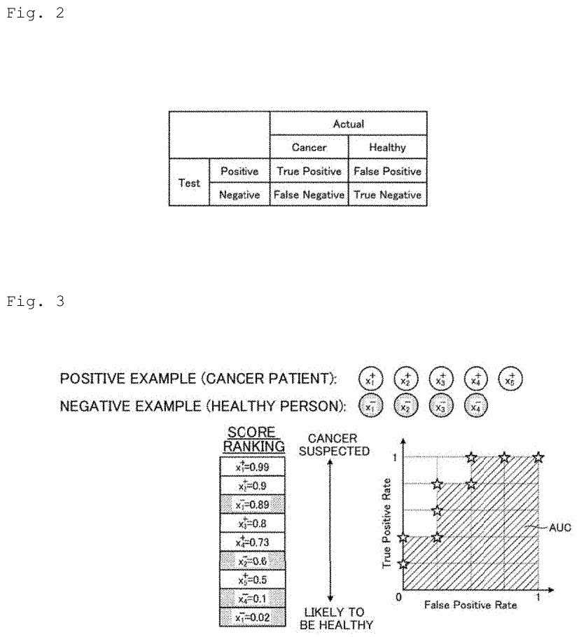

In the present embodiment, the classification result of a binary classification model is given True Positive (TP), False Positive (FP), False Negative (FN), or True Negative (TN), as illustrated in FIG. 2. FIG. 2 is a diagram for explaining classification results. Actual in FIG. 2 is a true class. Further, Test is a class estimated by a binary classification model. Further, in a task of classifying cancer patients and healthy people (not cancer people) into cancer patients or healthy people, a cancer patient (Cancer) and Positive are positive examples. Further, a healthy person (Healthy) and Negative are negative examples. For example, TP indicates that the binary classification model has correctly classified positive example data as a positive example. In addition, FP indicates that the binary classification model has erroneously classified negative example data as a positive example.

Further, a true positive rate TPR is represented by TP/(TP+FN). In other words, a TPR is a ratio of data classified as the positive examples to positive example data. On the other hand, a false positive rate FPR is represented by FP/(FP+TN). In other words, an FPR is a ratio of data classified as the positive examples to negative example data.

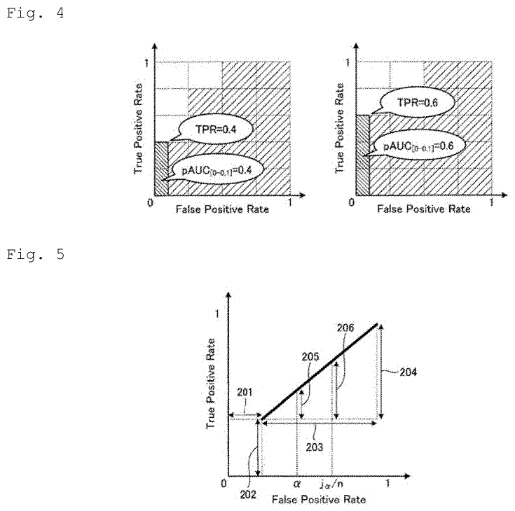

Next, an ROC curve and an AUC will be described with reference to FIG. 3. FIG. 3 is a diagram illustrating an example of an ROC curve and an AUC. Here, a binary classification model is used to classify cancer patients and healthy people (not-cancer people) into cancer patients or healthy people. In addition, a cancer patient is expressed by + as a positive example, and a healthy person is expressed by − as a negative example.

In the binary classification model of this example, scores are calculated from the test values and the like of 5 cancer patients and 4 healthy people. Here, the higher the score, the more cancer is suspected. For example, in the example of FIG. 3, the binary classification model calculates a score for patient x₁⁺ as 0.99. Also, for example, the binary classification model calculates a score for patient x₂⁻ as 0.6.

The binary classification model classifies patients who have a score equal to or higher than a threshold value as cancer patients and classifies patients who have a score lower than the threshold value as healthy people. At this time, by plotting the relationship between the FPR and TPR with the threshold values varying from 0 to 1, an ROC curve can be obtained as illustrated in FIG. 3. Further, the area (of a hatched region) under of the ROC curve corresponds to an AUC. In the example of FIG. 3, the area of the hatched region is 16/20=0.8, so that the AUC is 0.8.

Here, in some practical tasks, the true positive rate (TPR) for low false positive rate (FPR) region is regarded as being important. For example, in determining whether or not cancer is present, if there are many false positives, the cancer will be determined for many healthy people, which may be a problem in practical use in an actual hospital. Therefore, in practice, it is important how much cancer can be detected (for the true positive rate) when false positive is suppressed to some extent (e.g., the false positive rate is 1%, etc.). Not only for medical applications, but also for applications such as spam filters, or antivirus software, many false positives will unnecessarily annoy the user.

In such a case, it is desirable to maximize the true positive rate (TPR) for a certain false positive rate (e.g., when FPR=1%). Here, a method that aims to maximize the true positive rate for the target false positive rate by maximizing only a part of the AUC will be hereinafter referred to as a pAUC (partial AUC) maximization problem. FIG. 4 is a diagram illustrating an example in which AUCs are equal but pAUCs are different. The AUCs of the two empirical distributions illustrated in FIG. 4 are each 0.8. However, for an FPR of 0.1, the TPR is 0.4 on the left side and 0.6 on the right side. Further, in a section where the FPR is 0 to 0.1, the pAUC (represented as pAUC[0-0.1]) is 0.4 on the left side and 0.6 on the right side. In this way, the present invention aims to maximize the true positive rate at a desired false positive rate by maximizing the true positive rate in any false positive rate section, that is, pAUC.

The present embodiment maximizes a pAUC for a binary classification model. Further, the present embodiment aims to perform appropriate evaluation of the binary classification even when pieces of data having the same score are present in the target data. Note that, if the false positive rate section, which is specified for a pAUC, is set to be from 0 to 1, the pAUC and the AUC become equal, so that the pAUC maximization problem discussed in the present invention can also be applied to the AUC maximization problem.

As illustrated in FIG. 1, the classification device 10 includes an input unit 11, a learning unit 12, and a test unit 13. The input unit 11 receives input of data. The learning unit 12 trains a binary classification model. The test unit 13 classifies test data by using the trained binary classification model.

The learning unit 12 will be described. As illustrated in FIG. 1, the learning unit 12 includes a learning data acquisition unit 121, a feature extraction unit 122, a score calculation unit 123, an index calculation unit 124, an update unit 125, a convergence determination unit 126, and a parameter storage unit 127.

The learning data acquisition unit 121 acquires the input learning data. Further, the feature extraction unit 122 extracts features from the learning data to generate a feature vector. Here, the training data is one or more pieces of data that are each known to be a negative example or a positive example.

For example, for a classification of whether a person is healthy or unhealthy, the number of cigarettes smoked per day, BMI, the amount of alcohol consumed per day, and the like correspond to the feature values. The feature values may be manually designed by a person, or may be automatically designed by Deep Learning or the like. Further, the feature extraction unit 122 performs feature vectorization that converts the feature values into a feature vector by a technique such as N-gram or Bag-of-Words.

Positive example data set S⁺ in which the features have been extracted by the feature extraction unit 122 is represented as S⁺={(x₁⁺, y₁⁺), (x₂⁺, y₂⁺) . . . , (xₘ⁺, yₘ⁺)}. Further, negative example data set S in which the features have been extracted by the feature extraction unit 122 is represented as S⁻={(x₁⁻, y₁⁻), (x₂⁻, y₂⁻) . . . , (xₙ⁻, yₘ⁻)}. Here, m and n are the number of pieces of positive example data and the number of pieces of negative example data, respectively. Here, xₚ∈R^{D} is a feature vector of the feature values for the pth data point (D means the number of dimensions of the feature values), and yₚ ∈{+, −} is the class of the feature vector (positive example or negative example).

The score calculation unit 123 calculates a score for each of one or more pieces of data that are each known to be a negative example or a positive example by using a score function for calculating the score from features of the data according to parameters.

Here, w is a parameter vector of the binary classification model included in the score function, t∈R is a threshold value, and f(x; w) is the score function defined by w. Then, the binary classification model classifies data xₚ of the data point p as a positive example for f(xₚ, w)>t, and as a negative example for f(xₚ, w)<t. Further, the FPR section that is for pAUC is [α, β] (0≤<α<β≤1). In that case, TPR, FPR, AUC and pAUC can be calculated by Equations (1-1), (1-2), (1-3) and (1-4).

$$\begin{matrix}[ Formula 1 ] & \\ TRP = P [ f ( {x}^{+} ; w ) > \text{?} & ( 1 - 1 )\end{matrix}$$

$$FRP = P [ f ( {x}^{-} ; w ) > t ] \qquad ( 1 - 2 )$$

$$AUC = {\int }_{0}^{1} TPR ( {FPR}^{- 1} ( u ) ) du \qquad ( 1 - 3 )$$

$$pAUC ( α , β ) = \frac{1}{β - α} {\int }_{α}^{β} TPR ( {FPR}^{- 1} ( u ) ) du \qquad ( 1 - 4 )$$

$$where {FPR}^{- 1} ( u ) = inf \{ t ∈ ℝ \vert FPR ( t ) \leq u \}$$

$$\text{?} \text{indicates text missing or illegible when filed}$$

In (1-3), an AUC is calculated by integrating a TPR and an FPR. On the other hand, when approximation is performed with an empirical distribution, an AUC and a pAUC are calculated as in Equations (2-1) and (2-2).

$$\begin{matrix}[ Formula 2 ] & \\ AUC = \frac{1}{mn} {\sum }_{i = 1}^{m} {\sum }_{j = 1}^{n} I ( f ( {x}_{i}^{+} ; w ) > f ( {x}_{j}^{-} ; w ) ) & ( 2 - 1 )\end{matrix}$$

$$pAUC = \frac{1}{mn ( β - α )} {\sum }_{i = 1}^{m} [ \text{} ( {j}_{α} - n α ) \cdot I ( f ( {x}_{i}^{+} ; w ) > f ( {x}_{( {j}_{α} )}^{-} ; w ) ) + {\sum }_{j = {j}_{α} + 1}^{{j}_{β}} I ( \text{} f ( {x}_{i}^{+} ; w ) > f ( {x}_{( j )}^{-} ; w ) ) + ( n β - {j}_{β} ) \cdot I ( f ( {x}_{i}^{+} ; w ) > f ( {x}_{( {j}_{β} + 1 )}^{-} ; w ) ) ] \qquad ( 2 - 2 )$$

Here, j_{α} is the smallest integer greater than or equal to n_{α}. Further, j_{β} is the smallest integer greater than or equal to no. Further, I is the Heaviside step function. Further, x₍ⱼ₎⁻ means negative example data whose score calculated based on the score function f is the top jth.

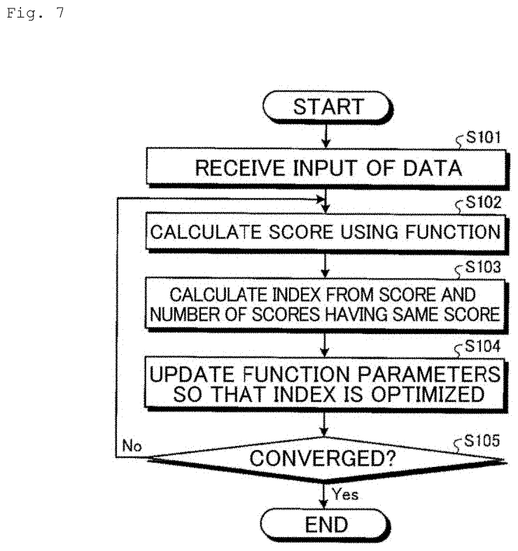

However, the approximate values of the AUC and pAUC calculated by Equations (2-1) and (2-2) may deviate significantly from the respective values based on an actual ROC curve. For example, in the example of FIG. 6, the scores of x₂⁺, x₃⁺, x₄⁺, x₂⁻, and x₃⁻ are all 0.7 and equal. Here, in calculation using Equations (2-1) and (2-2), the TPR is invariant in an FPR range of 0.25 or more and less than 0.75. Accordingly, in the example of FIG. 6, the AUC obtained from the ROC curve is 11/20=0.55, while the AUC obtained from the empirical distribution is 8/20=0.4, so that these AUCs deviate significantly from each other. Further, it is considered that the binary classification model cannot be optimized well with such AUC and pAUC.

In this respect, the index calculation unit 124 of the present embodiment calculates, in a specified FPR range, an index that increases more as the score of the positive example is higher than the score of negative example, the index taking into account data whose scores are equal among the data in the calculation range.

The index calculation unit 124 calculates, in a result of classification from a classification performed based on the score calculated by the score calculation unit 123, an index that increases as a true positive rate for a false positive rate being within a predetermined section increases, the index increasing as a ratio of positive example data to data whose score is equal to a predetermined value increases. Further, the index calculation unit 124 approximates the area of the region surrounded by the ROC curve and the axis of the false positive rate with an empirical distribution, and calculates the resulting area as an index.

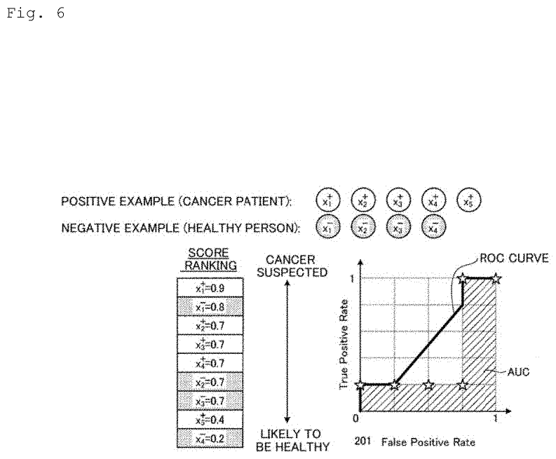

First, a method of calculating the lengths of respective parts related to an empirical distribution will be described with reference to FIG. 5. FIG. 5 is a diagram for explaining the method of calculating the lengths of respective parts related to the empirical distribution. The index calculation unit 124 calculates the length of a part indicated by reference numeral 201 by Equation (3-1). Further, the index calculation unit 124 calculates the length of a part indicated by reference numeral 202 by Equation (3-2). Further, the index calculation unit 124 calculates the length of a part indicated by reference numeral 203 by Equation (3-3). Further, the index calculation unit 124 calculates the length of a part indicated by reference numeral 204 by Equation (3-4). Further, the index calculation unit 124 calculates the length of a part indicated by reference numeral 205 by Equation (3-5). Further, the index calculation unit 124 calculates the length of a part indicated by reference numeral 206 by Equation (3-6).

$$\begin{matrix}[ Formula 2 ] & \\ \frac{1}{2} {\sum }_{j = 1}^{n} I ( f ( {x}_{j}^{-} ; w ) > f ( {x}_{( {j}_{α} )}^{-} ; w ) ) & ( 3 - 1 )\end{matrix}$$

$$\frac{1}{m} {\sum }_{i = 1}^{m} I ( f ( {x}_{i}^{+} ; w ) > f ( {x}_{( {j}_{α} )}^{-} ; w ) ) \qquad ( 3 - 2 )$$

$$\frac{1}{n} {\sum }_{j = 1}^{n} I ( f ( {x}_{j}^{-} ; w ) = f ( {x}_{( {j}_{α} )}^{-} ; w ) ) \qquad ( 3 - 3 )$$

$$\frac{1}{m} {\sum }_{i = 1}^{m} I ( f ( {x}_{i}^{+} ; w ) = f ( {x}_{( {j}_{α} )}^{-} ; w ) ) \qquad ( 3 - 4 )$$

$$\frac{1}{m} ( n α - {\sum }_{j = 1}^{n} I ( f ( {x}_{j}^{-} ; w ) > f ( {x}_{( {j}_{α} )}^{-} ; w ) ) ) \frac{{\sum }_{i = 1}^{m} I ( f ( {x}_{i}^{+} ; w ) = f ( {x}_{( {j}_{α} )}^{-} ; w ) )}{{\sum }_{j = 1}^{n} I ( f ( {x}_{j}^{-} ; w ) = f ( {x}_{( {j}_{α} )}^{-} ; w ) )} \qquad ( 3 - 5 )$$

$$\frac{1}{m} ( {j}_{α} - {\sum }_{j = 1}^{n} I ( f ( {x}_{j}^{-} ; w ) > f ( {x}_{( {j}_{α} )}^{-} ; w ) ) ) \frac{{\sum }_{i = 1}^{m} I ( f ( {x}_{i}^{+} ; w ) = f ( {x}_{( {j}_{α} )}^{-} ; w ) )}{{\sum }_{j = 1}^{n} I ( f ( {x}_{j}^{-} ; w ) = f ( {x}_{( {j}_{α} )}^{-} ; w ) )} \qquad ( 3 - 6 )$$

The index calculation unit 124 calculates a pAUC for each of [α, j_{α}/n] section, [j_{α}/n, j_{β}/n] section, and [j_{β}/n, γ] section. Note that, for α=0 and β=1, pAUC becomes equal to AUC, and accordingly, both AUC and pAUC are simply referred to as pAUC in the following description. The index calculation unit 124 calculates the area of the trapezoid in each section.

The index calculation unit 124 calculates pAUC₁ for [α, j_{α}/n] section as in Equation (4).

$$\begin{matrix}[ Formula 4 ] & \\ < ⌈ α , {j}_{α} / n ⌉ section ( for {j}_{α} \neq 0 ) > & ( 4 )\end{matrix}$$

$${pAUC}_{1} = \frac{1}{mn ( β - α )} ( {j}_{α} - n α ) \cdot [ {\sum }_{i = 1}^{m} I ( f ( {x}_{i}^{+} ; w ) > f ( {x}_{( {j}_{α} )}^{-} ; w ) ) - {\sum }_{j = 1}^{n} I ( f ( {x}_{j}^{-} ; w ) > f ( {x}_{( {j}_{α} )}^{-} ; w ) ) \frac{{\sum }_{i = 1}^{m} I ( f ( {x}_{i}^{+} ; w ) = f ( {x}_{( {j}_{α} )}^{-} ; w ) )}{{\sum }_{j = 1}^{n} I ( f ( {x}_{j}^{-} ; w ) = f ( {x}_{( {j}_{α} )}^{-} ; w ) )} + \frac{1}{2} ( {j}_{α} + n α ) \frac{{\sum }_{i = 1}^{m} I ( f ( {x}_{i}^{+} ; w ) = f ( {x}_{( {j}_{α} )}^{-} ; w ) )}{{\sum }_{j = 1}^{n} I ( f ( {x}_{j}^{-} ; w ) = f ( {x}_{( {j}_{α} )}^{-} ; w ) )} ]$$

Further, the index calculation unit 124 calculates pAUC_{c} for [j_{α}/n, j_{β}/n] section as in Equation (5).

$$\begin{matrix}[ Formula 5 ] & \\ < ⌈ {j}_{α} / n , {j}_{β} / n ⌉ section > & ( 5 )\end{matrix}$$

$${pAUC}_{2} = \frac{1}{mn ( β - α )} {\sum }_{i = 1}^{m} {\sum }_{j = {j}_{α} + 1}^{{j}_{β}} \{ I ( f ( {x}_{i}^{-} ; w ) > f ( {x}_{( j )}^{-} ; w ) ) + \frac{1}{2} I ( f ( {x}_{i}^{+} ; w ) = f ( {x}_{( j )}^{-} ; w ) ) \}$$

Further, the index calculation unit 124 calculates pAUCᵣ [j_{α}/n for j_{β}/n] section as in Equation (6).

$$\begin{matrix}[ Formula 5 ] & \\ < ⌈ {j}_{β} / n , β ⌉ section ( for β \neq n ) > & ( 6 )\end{matrix}$$

$${pAUC}_{r} = \frac{1}{mn ( β - α )} ( β - {j}_{β} ) \cdot [ {\sum }_{i = 1}^{m} I ( f ( {x}_{i}^{+} ; w ) > f ( {x}_{( {j}_{β} + 1 )}^{-} ; w ) ) - {\sum }_{j = 1}^{n} I ( f ( {x}_{j}^{-} ; w ) > f ( {x}_{( {j}_{β} + 1 )}^{-} ; w ) ) \frac{{\sum }_{i = 1}^{m} I ( f ( {x}_{i}^{+} ; w ) = f ( {x}_{( {j}_{β} + 1 )}^{-} ; w ) )}{{\sum }_{j = 1}^{n} I ( f ( {x}_{j}^{-} ; w ) = f ( {x}_{( {j}_{β} + 1 )}^{-} ; w ) )} - \frac{1}{2} ( n β + {j}_{β} ) \frac{{\sum }_{i = 1}^{m} I ( f ( {x}_{i}^{+} ; w ) = f ( {x}_{( {j}_{β} + 1 )}^{-} ; w ) )}{{\sum }_{j = 1}^{n} I ( f ( {x}_{j}^{-} ; w ) = f ( {x}_{( {j}_{β} + 1 )}^{-} ; w ) )} ]$$

Note that, for j_{α}=0, pAUC₁ is 0. Further, for j_{β}=n, pAUCᵣ is 0.

Further, the index calculation unit 124 calculates a pAUC that is the combined areas of all the sections as in Equation (7).

[Formula 7]

pAUC=pAUCᵢ+pAUC_{c}+pAUCᵣ (7)

In this way, the index calculation unit 124 can calculate an index which is a value obtained by multiplying the area of a part (partial AUC) for a predetermined section of false positive rate by a ratio of the number of pieces of positive example data to the number of pieces of negative example data in data whose score is equal to a predetermined value, in a region surrounded by an ROC curve on a plane with axes of true positive rate and false positive rate which indicate classification results and the axis of false positive rate.

Here, the fractional part appearing in Equation (3-5) and the others is a magnification in consideration of the number of pieces of data having the same score. In this way, the index calculation unit 124 reduces the discrepancy between a pAUC based on an empirical distribution and a pAUC of an actual ROC curve when a score is drawn.

Here, the Heaviside step function I representing an empirical distribution is not differentiable. Therefore, the index calculation unit 124 calculates the index by replacing it with a continuous function that is differentiable with respect to a parameter. The index calculation unit 124 approximates, for example, the inequality sign part of the Heaviside step function I with a logistic sigmoid function, as represented in Equation (8).

[Formula 8]

σ(x⁺,x⁻;w)=[1+exp[−(ƒ(x⁺)−ƒ(x⁻))]]]⁻¹ (8)

Further, the index calculation unit 124 approximates the equal sign part of the Heaviside step function I with, for example, an exponential function having a maximum value of 1, as illustrated in Equation (9).

$$\begin{matrix}[ Formula 9 ] & \\ v ( {x}^{+} , {x}^{-} ; w ) = exp ( - \frac{{( f ( {x}^{+} ) - f ( {x}^{-} ) )}^{2}}{\text{?}} ) & ( 9 )\end{matrix}$$

$$\text{?} \text{indicates text missing or illegible when filed}$$

where [symbol] is a hyperparameter which means variance.

The pAUC for each section after the replacement is expressed as Equations (10), (11), and (12).

$$\begin{matrix}[ Formula 10 ] & \\ < ⌈ α , {j}_{α} / n ⌉ section ( for {j}_{α} \neq 0 ) > & ( 10 )\end{matrix}$$

$$\frac{1}{mn ( β - α )} ( {j}_{α} - n α ) \cdot [ {\sum }_{i = 1}^{m} σ ( {x}_{i}^{+} , {x}_{( {j}_{α} )}^{-} ; w ) - {\sum }_{j = 1}^{n} σ ( {x}_{j}^{-} , {x}_{( {j}_{α} )}^{-} ; w ) \frac{{\sum }_{i = 1}^{m} v ( \text{?} , {x}_{( {j}_{α} )}^{-} ; w )}{{\sum }_{j = 1}^{n} v ( \text{?} , {x}_{( {j}_{α} )}^{-} ; w )} + \frac{1}{2} ( {j}_{α} + n α ) \frac{{\sum }_{i = 1}^{m} v ( {x}_{i}^{+} , {x}_{( {j}_{α} )}^{-} ; w )}{{\sum }_{j = 1}^{n} v ( {x}_{j}^{-} , {x}_{( {j}_{α} )}^{-} ; w )} ]$$

$$\begin{matrix}[ Formula 11 ] & \\ < ⌈ {j}_{α} / n , {j}_{β} / n ⌉ section > \\ \frac{1}{mn ( β - α )} {\sum }_{i = 1}^{m} {\sum }_{j = {j}_{α} + 1}^{{j}_{β}} \{ σ ( \text{?} , {x}_{( {j}_{α} )}^{-} ; w ) + \frac{1}{2} v ( \text{?} , {x}_{( j )}^{-} ; w ) \} & ( 11 )\end{matrix}$$

$$\begin{matrix}[ Formula 12 ] & \\ < ⌈ {j}_{β} / n , β ⌉ section ( for β \neq n ) > & ( 12 )\end{matrix}$$

$$\frac{1}{mn ( β - α )} ( n β - {j}_{β} ) \cdot [ \text{} {\sum }_{i = 1}^{m} σ ( {x}_{i}^{+} , {x}_{( {j}_{β} + 1 )}^{-} ; w ) - {\sum }_{j = 1}^{n} σ ( {x}_{i}^{+} , {x}_{( {j}_{β} + 1 )}^{-} ; w ) \frac{{\sum }_{i = 1}^{m} v ( {x}_{i}^{+} , {x}_{( {j}_{β} + 1 )}^{-} ; w )}{{\sum }_{j = 1}^{n} v ( {x}_{j}^{-} , {x}_{( {j}_{β} + 1 )}^{-} ; w )} + \frac{1}{2} ( n β - {j}_{β} ) \frac{{\sum }_{i = 1}^{m} v ( {x}_{i}^{+} , {x}_{( {j}_{β} + 1 )}^{-} ; w )}{{\sum }_{j = 1}^{n} v ( {x}_{j}^{-} , {x}_{( {j}_{β} + 1 )}^{-} ; w )} ]$$

$$\text{?} \text{indicates text missing or illegible when filed}$$

The update unit 125 updates the parameter(s) based on the gradient with respect to a parameter of the index. For example, the update unit 125 takes a logarithm of pAUC and optimizes an objective function expressed by Equation (16) with a normalized term added. R(w) is a normalized function, such as L1 normalization (∥w∥) and L2 normalization (∥W∥²). Further, in Equation (16), s(xᵢ⁺, x₍ⱼ₎⁻) defined as Equations (13), (14), and (15) according to the value of j is introduced. However, J is an integer of j_{α}+1 or more and j_{β} or less.

$$\begin{matrix}[ Formula 13 ] & \\ s ( {x}_{i}^{+} , {x}_{( {j}_{α} )}^{-} ) = ( {j}_{α} - n α ) \cdot [ σ ( {x}_{i}^{+} , {x}_{( {j}_{α} )}^{-} ; w ) - {\sum }_{j = 1}^{n} σ ( {x}_{j}^{-} , {x}_{( {j}_{α} )}^{-} ; w ) \frac{v ( {x}_{i}^{+} , {x}_{( {j}_{α} )}^{-} ; w )}{{\sum }_{j = 1}^{n} v ( {x}_{j}^{-} , {x}_{( {j}_{α} )}^{-} ; w )} + \frac{1}{2} ( {j}_{α} + n α ) \frac{v ( {x}_{i}^{+} , {x}_{( {j}_{α} )}^{-} ; w )}{{\sum }_{j = 1}^{n} v ( {x}_{j}^{-} , {x}_{( {j}_{α} )}^{-} ; w )} ] & ( 13 )\end{matrix}$$

$$\begin{matrix}[ Formula 14 ] & \\ s ( {x}_{i}^{+} , {x}_{( j )}^{-} ) = σ ( {x}_{i}^{+} , {x}_{( {j}_{α} )}^{-} ; w ) + \frac{1}{2} v ( {x}_{i}^{+} , {x}_{( j )}^{-} ; w ) & ( 14 )\end{matrix}$$

$$\begin{matrix}[ Formula 15 ] & \\ s ( {x}_{i}^{+} , {x}_{( {j}_{β} + 1 )}^{-} ) = ( n β - {j}_{β} ) \cdot [ \text{} σ ( {x}_{i}^{+} , {x}_{( {j}_{β} + 1 )}^{-} ; w ) - {\sum }_{j = 1}^{n} σ ( {x}_{i}^{+} , {x}_{( {j}_{β} + 1 )}^{-} ; w ) \frac{v ( {x}_{i}^{+} , {x}_{( {j}_{β} + 1 )}^{-} ; w )}{{\sum }_{j = 1}^{n} v ( {x}_{j}^{-} , {x}_{( {j}_{β} + 1 )}^{-} ; w )} + \frac{1}{2} ( n β + {j}_{β} ) \frac{v ( {x}_{i}^{+} , {x}_{( {j}_{β} + 1 )}^{-} ; w )}{{\sum }_{j = 1}^{n} v ( {x}_{j}^{-} , {x}_{( {j}_{β} + 1 )}^{-} ; w )} ] & ( 15 )\end{matrix}$$

$$\begin{matrix}[ Formula 16 ] & \\ E = log ( {\sum }_{i = 1}^{m} {\sum }_{j = {j}_{α}}^{{j}_{β} + 1} s ( \text{?} , {x}_{( j )}^{-} ) ) - CR ( w ) & ( 16 )\end{matrix}$$

$$\text{?} \text{indicates text missing or illegible when filed}$$

The update unit 125 updates the parameter vector w and determines the score function f(x; w) so that the objective function is optimized. Note that, initially, any initial values may be set in the parameter(s). The update unit 125 can perform optimization by any method such as a stochastic gradient descent method, a Newton method, a quasi-Newton method (L-BFGS or the like), or a conjugate gradient method. Note that the objective function is not limited to that of Equation (13), and may be in a form in which logarithm is not introduced.

The convergence determination unit 126 determines whether or not the parameter(s) updated by the update unit 125 satisfies a predetermined convergence condition. Further, when the convergence determination unit 126 determines that the parameter(s) do not satisfy the convergence condition, the score calculation unit 123 further calculates the score by using the score function according to the parameter(s) updated by the update unit 125. Further, when the convergence determination unit 126 determines that convergence has occurred, the convergence determination unit 126 stores the parameter w in the parameter storage unit 127.

The convergence determination unit 126 may determine that convergence has occurred if a difference between the objective functions before and after the update is equal to or less than a desired value, or may determine that convergence has occurred if a difference between the parameter vectors w before and after the update is equal to or less than a desired value. Further, it can be said that the parameter vector w for which the convergence determination unit 126 determines that convergence has occurred is the solution of the pAUC maximization problem.

Returning to FIG. 1, the configuration of the test unit 13 will be described. As illustrated in FIG. 1, the test unit 13 includes a test data acquisition unit 131, a feature extraction unit 132, a score calculation unit 133, and a determination unit 134. Further, an output unit 14 outputs a result of the binary classification.

The test data acquisition unit 131 acquires the input test data. The test data is data for which it is unknown whether it is a negative example or a positive example. The feature extraction unit 132 and the score calculation unit 133 have the same functions as the feature extraction unit 122 and the score calculation unit 123. However, the score calculation unit 133 acquires the updated parameter w from the parameter storage unit 127, and generates a score function f(w; x) based on the parameter w.

The determination unit 134 performs the classification depending on whether or not the score calculated by the score function exceeds a threshold value. In other words, the determination unit 134 determines whether or not the score calculated according to the parameter(s) updated by the update unit 125 exceeds the threshold value. For example, the determination unit 134 determines that the data whose score exceeds the threshold value is a positive example, and the data whose score is equal to or less than the threshold value is a negative example.

[Processing of First Embodiment]

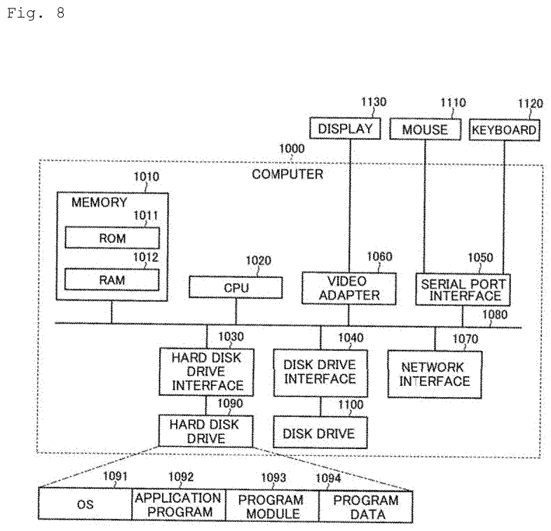

FIG. 7 is a flowchart illustrating a flow of learning processing of the classification device according to the first embodiment. As illustrated in FIG. 7, first, the classification device 10 receives input of data (step S101). Next, the classification device 10 calculates a score by using the function (step S102).

Here, the classification device 10 calculates the objective function from the score and the number of pieces of data having the same score. Specifically, the classification device 10 calculates pAUCs by Equations (4), (5), and (6) (step S103).

Then, the classification device 10 updates the parameter(s) of the function so that the objective function is optimized (step S104). When it is determined that the parameter update has converged (step S105, Yes), the classification device 10 ends the processing. On the other hand, when it is determined that the parameter update has not converged (step S105, No), the classification device 10 returns the processing to step 3102 to repeat the processing from step S102.

[Effect of First Embodiment]

As described above, the score calculation unit 133 calculates a score for each of one or more pieces of data that are each known to be a negative example or a positive example by using a score function for calculating the score from features of the data according to parameters. Further, the index calculation unit 124 calculates, in a result of classification from a classification performed based on the score calculated by the score calculation unit 123, an index that increases as a true positive rate for a false positive rate being within a predetermined section increases, the index increasing as a ratio of positive example data to data whose score is equal to a predetermined value increases. Further, the update unit 125 updates the parameter(s) so that the index calculated by the index calculation unit 124 is optimized.

In this way, the classification device 10 calculates an index in consideration of the number of pieces of data having the same score. Thus, according to the classification device 10, it is possible to perform appropriate evaluation of the binary classification even when pieces of data having the same score are present in the target data.

The index calculation unit 124 can calculate an index which is a value obtained by multiplying the area of a part (partial AUC) for a predetermined section of false positive rate by a ratio of the number of pieces of positive example data to the number of pieces of negative example data in data whose score is equal to a predetermined value, in a region surrounded by an ROC curve on a plane with axes of true positive rate and false positive rate which indicate classification results and the axis of false positive rate. Thus, the classification device 10 can calculate the index by using the method of calculating an AUC.

The index calculation unit 124 approximates the area of the region surrounded by the ROC curve and the axis of the false positive rate with an empirical distribution, and calculates the resulting area as an index. Thus, the classification device 10 can calculate the index even when an accurate ROC curve is not obtained.

The index calculation unit 124 calculates the index by replacing a part approximated with an empirical distribution with a continuous function that is differentiable with respect to a parameter. The update unit 125 can update the parameter(s) based on the gradient with respect to a parameter of the index. As a result, even when a function that is not differentiable such as the Heaviside step function is used for the calculation of the index, the classification device 10 can perform optimization using the gradient.

The convergence determination unit 126 can determine whether or not the parameter(s) updated by the update unit 125 satisfies a predetermined convergence condition. Further, then, when the convergence determination unit 126 determines that the parameter(s) do not satisfy the convergence condition, the score calculation unit 123 further calculates the score by using the score function according to the parameter(s) updated by the update unit 125. In this way, the classification device 10 can obtain a solution to the pAUC maximization problem by repeatedly updating the parameter(s).

[System Configuration, etc.]

Further, each component of each device illustrated is a functional concept and does not necessarily need to be physically configured as illustrated. In other words, a specific form of distribution and integration of the devices is not limited to the illustrated one, and all or a part thereof may be functionally or physically distributed or integrated on any unit basis in accordance with various loads and usage conditions. Further, all or any part of each processing function performed by each device can be implemented by a CPU and a program analyzed and executed by the CPU, or can be implemented as hardware by wired logic.

Further, among the processing described in the embodiment, all or a part of the processing described as being performed automatically can be manually performed, or all or a part of the processing described as being performed manually can be performed automatically by a known method. In addition, the processing procedures, control procedures, specific names, and information including various data and parameters described in the above documents and drawings can be arbitrarily changed unless otherwise specified.

[Program]

In one embodiment, the classification device 10 can be implemented by a classification program being installed as package software or online software on a desired computer, the classification program executing the classification processing described above. For example, an information processing device executing the learning or classification program described above makes it possible to cause the information processing device to function as the classification device 10. The information processing device referred to here includes a desktop type or laptop type personal computer. Further, other examples of the information processing device include a mobile communication terminal such as a smartphone, a mobile phone, PHS (Personal Handyphone System); a slate terminal such as PDA (Personal Digital Assistant); and the like.

Further, the classification device 10 can be implemented as a classification server device that provides a service related to the learning or classification processing described above to a client corresponding to a terminal device used by a user. For example, the classification server device is implemented as a server device that provides a classification service that receives graph data as input and outputs results of graph signal processing or graph data analysis. In this case, the classification server device may be implemented as a Web server, or may be implemented as a cloud that provides services related to the classification processing described above by outsourcing.

FIG. 8 is a diagram illustrating an example of a computer that executes a classification program. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These components are connected by a bus 1080.

The memory 1010 includes a ROM (Read Only Memory) 1011 and a RAM 1012. The ROM 1011 stores, for example, a boot program such as a BIOS (Basic Input Output System). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. Accordingly, a program that defines each processing in the classification device 10 is implemented as the program module 1093 in which codes executable by the computer are described. The program module 1093 is stored in, for example, the hard disk drive 1090. For example, the program module 1093 for executing processing corresponding to the functional configuration of the classification device 10 is stored in the hard disk drive 1090. Note that the hard disk drive 1090 may be replaced by an SSD.

Further, setting data used in the processing in the above-described embodiment is stored as the program data 1094 in, for example, the memory 1010 or the hard disk drive 1090. Then, the CPU 1020 loads the program module 1093 and the program data 1094 stored in the memory 1010 or the hard disk drive 1090, into the RAM 1012 as necessary, to execute the processing of the above-described embodiment.

Note that the program module 1093 and the program data 1094 are not limited to being stored in the hard disk drive 1090, but may be stored in, for example, a removable storage medium and read out by the CPU 1020 via the disk drive 1100 or the like. Alternatively, the program module 1093 and the program data 1094 may be stored in another computer connected via a network (LAN (Local Area Network), WAN (Wide Area Network), etc.). Then, the program module 1093 and the program data 1094 may be read from the other computer by the CPU 1020 via the network interface 1070.

### REFERENCE SIGNS LIST

10 Classification device
11 Input unit
12 Learning unit
13 Test unit
14 Output unit
121 Learning data acquisition unit
122 Feature extraction unit
123 Score calculation unit
124 Index calculation unit
125 Update unit
126 Convergence determination unit
127 Parameter storage unit
131 Test data acquisition unit
132 Feature extraction unit
133 Score calculation unit
134 Determination unit

1. A learning device, comprising:
score calculation circuitry that calculates a score for each of one or more pieces of data that are each known to be a negative example or a positive example by using a score function for calculating the score from a feature of the data according to a parameter;
index calculation circuitry that calculates, in a result of classification from a classification performed based on the score calculated by the score calculation circuitry, an index that increases as a true positive rate for a false positive rate being within a predetermined section increases, the index increasing as a ratio of positive example data to data whose score is equal to a predetermined value increases; and
update circuitry that updates the parameter so that the index calculated by the index calculation circuitry is optimized.

2. The learning device according to claim 1, wherein:
the index calculation circuitry calculates the index that is a value obtained by multiplying the area of a part (partial AUC) for a predetermined section of false positive rate by a ratio of the number of pieces of positive example data to the number of pieces of negative example data in data whose score is equal to a predetermined value, in a region surrounded by an ROC curve on a plane with axes of true positive rate and false positive rate which indicate the classification result and the axis of false positive rate.

3. The learning device according to claim 2, wherein:
the index calculation circuitry approximates an area of a part surrounded by an ROC curve (Receiver Operating Characteristic) and the axis of the false positive rate with an empirical distribution to calculate the area as the index.

4. The learning device according to claim 3, wherein:
the index calculation circuitry calculates the index by replacing an expression approximated with the empirical distribution with a continuous function that is differentiable with respect to the parameter, and
the update circuitry updates the parameter based on a gradient of the index with respect to the parameter.

5. The learning device according to claim 1, further comprising:
convergence determination circuitry that determines whether the parameter updated by the update circuitry satisfies a predetermined convergence condition,
wherein, when the convergence determination circuitry determines that the parameter does not satisfy the convergence condition, the score calculation circuitry further calculates the score by using the score function according to the parameter updated by the update circuitry.

6. A classification device comprising:
a score calculation circuitry that calculates a score for each of one or more pieces of data that are each known to be a negative example or a positive example by using a score function for calculating the score from a feature of the data according to a parameter;
an index calculation circuitry that calculates, in a result of classification from a classification performed based on the score calculated by the score calculation circuitry, an index that increases as a true positive rate for a false positive rate being within a predetermined section increases, the index increasing as a ratio of positive example data to data whose score is equal to a predetermined value increases;
an update circuitry that updates the parameter so that the index calculated by the index calculation circuitry is optimized; and
a determination circuitry that determines whether the score calculated according to the parameter updated by the update circuitry exceeds a threshold value.

7. A learning method performed by a computer, the learning method comprising:
a score calculation step of calculating a score for each of one or more pieces of data that are each known to be a negative example or a positive example by using a score function for calculating the score from a feature of the data according to a parameter;
an index calculation step of calculating, in a result of classification from a classification performed based on the score calculated at the score calculation step, an index that increases as a true positive rate for a false positive rate being within a predetermined section increases, the index increasing as a ratio of positive example data to data whose score is equal to a predetermined value increases; and
an update step of updating the parameter so that the index calculated at the index calculation step is optimized.

8. A non-transitory computer readable medium storing a learning program for causing a computer to perform the method of claim 7.
